(19) United States
(12) Patent Application Publication
(10) Pub. No.: US 2014/0027935 A1
(43) Pub. Date: Jan. 30, 2014

(54) METHOD AND SYSTEM FOR LASER ABRASION OF OPTICAL FIBERS

(71) Applicant: THERMOTEK, INC., Flower Mound, TX (US)

(72) Inventors: Tony Quisenberry, Highland Village, TX (US); Todd Davis Taber, Keller, TX (US); Thomas Clayton Anderson, Frisco, TX (US)

(73) Assignee: ThermoTek, Inc., Flower Mound, TX (US)

(21) Appl. No.: 13/793,929

(22) Filed: Mar. 11, 2013

Related U.S. Application Data
(60) Provisional application No. 61/676,675, filed on Jul. 27, 2012.

(51) Int. Cl. B29C 59/16

(52) U.S. Cl. CPC B29C 59/16
USPC 264/1.27; 425/174.4

(57) ABSTRACT

In one aspect, the present invention relates to a system for abrasion of optical fibers. The system includes an adjustment member, a platform disposed on the adjustment member, and a focus block disposed on the platform. A laser is disposed above, and is in optical alignment with, the focus block. The laser abrades an optical fiber positioned on the focus block.

### CROSS-REFERENCE TO RELATED APPLICATIONS

This application claims priority to, and incorporates by reference, for any purpose, the entire disclosure of, U.S. Provisional Patent Application No. 61/676,675, filed Jul. 27, 2012.

### BACKGROUND

1. Field of the Invention

The present application relates generally to optical fibers and more particularly, but not by way of limitation, to methods and systems for utilizing a laser to abrade optical fibers.

2. History of the Related Art

An optical fiber is a flexible transparent fiber that functions as a wave guide, or “light pipe”, to transmit light between two ends of the optical fiber. Optical fibers are widely used in communication, illumination, and in many devices such as sensors and fiber lasers. In many applications, optical fibers are preferable to metal wires because optical fibers transmit signals with less loss and are immune to electromagnetic interference.

Optical fibers are useful as a medium for telecommunication and networking because optical fibers are generally of small diameter, flexible, and may be bundled as cables. Optical fibers are particularly well-suited to long-distance communications due to the fact that light propagates through the optical fiber with little attenuation when compared to electrical cables. In addition, optical fibers are well-suited for use in confined spaces such as cable ducts and conduits. This is because a single optical fiber is capable of carrying more data than a comparable electrical cable. Since, optical fibers are immune to electromagnetic interference, there is no cross-talk between signals in different cables, and no pickup of environmental noise.

Optical fibers are also widely utilized in illumination applications. In particular, optical fibers are utilized as light guides in medical applications requiring illumination of a target without a clear line-of-sight path. In illumination applications, it is often necessary to design the optical fiber to emit light in a direction generally perpendicular to a long axis of the optical fiber. In such applications, the optical fiber is often abraded, or otherwise marred, to remove one or more layers of the optical fiber thus allowing light to escape a core of the optical fiber in a direction generally perpendicular to the long axis of the optical fiber.

Prior methods of abrading optical fibers include mechanical abrasion. U.S. Pat. No. 5,312,570, assigned to Poly-Optical Products, Inc., discloses a system and method for prepare fiber-optic ribbons. The system utilizes a flat abrasion panel that directly contacts a fiber-optic ribbon. In addition, U.S. Pat. Nos. 5,312,569 and 5,499,912, also assigned to Poly-Optical Products, Inc., each disclose a method and system for marring optical fibers by feeding a fiber-optic substrate through a pair of rotating rollers.

U.S. Pat. No. 7,198,550, assigned to 3M Innovative Products Company discusses a process for abrading an end surface of an optical-fiber connector. The process utilizes an abrasive film entrained with abrasive grains in combination with a liquid lubricant. Finally, U.S. Pat. No. 6,922,519, assigned to Lumitex, Inc., discusses a method for marring optical fibers by pressing an abrasive roller onto a fiber-optic substrate.

### SUMMARY

The present application relates generally to preparation of optical fibers and more particularly, but not by way of limitation, to methods and systems for utilizing a laser to abrade optical fibers. In one aspect, the present invention relates to a system for abrasion of optical fibers. The system includes an adjustment member, a platform disposed on the adjustment member, and a focus block disposed on the platform. A laser is disposed above, and is in optical alignment with, the focus block. The laser abrades an optical fiber positioned on the focus block.

In another aspect, the present invention relates to a method for abrading optical fibers. The method includes positioning an optical fiber on a focus block. A laser is focused on the optical fiber via an adjustment member positioned under the focus block for abrading the optical fiber.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1A is a cross-sectional view of an optical fiber;

FIG. 1B is a cross-sectional view of an optical fiber after abrasion;

FIG. 2 is a schematic diagram of a system for abrasion of optical fibers according to an exemplary embodiment;

FIG. 3 is a schematic diagram of a system for abrasion of optical fibers using an automated input according to an exemplary embodiment;

FIG. 4 is a flow diagram of a method for abrading optical fibers according to an exemplary embodiment; and

FIGS. 5A-5D are illustrations of laser etch patterns according to exemplary embodiments.

### DETAILED DESCRIPTION

Various embodiments of the present invention will now be described more fully with reference to the accompanying drawings. The invention may, however, be embodied in many different forms and should not be construed as limited to the embodiments set forth herein.

Optical fibers typically include a transparent core surrounded by a transparent cladding material which has a lower index of refraction. Light is maintained in the core by total internal reflection. Total internal reflection is an optical phenomenon occurring when light strikes a boundary of a particular medium at an angle larger than a critical angle. If the refractive index is lower on the other side of the boundary, and the incident angle is greater than the critical angle, no light can pass through the boundary and all light is reflected into the medium. Optical fibers that support many propagation paths or transverse modes are called multi-mode fibers, while those that support a single mode are called single-mode fibers.

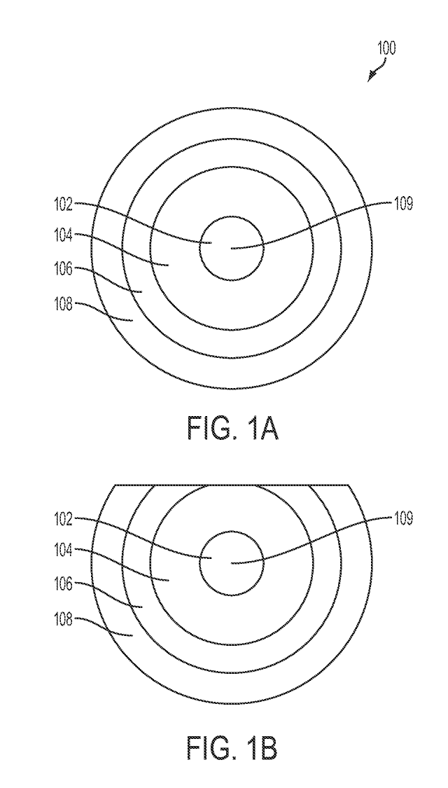

FIG. 1A is a cross-sectional view of an optical fiber. An optical fiber 100 includes a transparent core 102 surrounded by a cladding 104. A buffer 106 surrounds the cladding 104 and a jacket 108 surrounds the buffer 106. In a typical embodiment, the transparent core 102 is made from a material such as, for example, silica. However, in other embodiments, the transparent core 102 may be manufactured from materials such as, for example, fluorozirconate, fluoroaluminate, acrylic, and crystalline materials such as, for example, sapphire. In a typical embodiment, the cladding 104 is manufactured from a material having a lower index of refraction than the transparent core 102. The cladding 104 traps light in the transparent core 102 through total internal reflection. The buffer 106 surrounds the cladding 104 and is concentric with the cladding 104. In a typical embodiment, the buffer 106 is manufactured from a tough material such as, for example, resin. The jacket 108 surrounds, and is concentric with, the buffer 106. In a typical embodiment, the jacket 108 is manufactured from a material such as, for example, glass. In a typical embodiment, the buffer 106 and the jacket 108 add strength to the optical fiber 100 but do not contribute to the optical properties of the optical fiber 100.

FIG. 1B is a cross-sectional view of an optical fiber after abrasion. During abrasion, at least a portion of the jacket 108, the buffer 106, and the cladding 104 are removed from the transparent core 102. Typically, abrasion removes approximately 10% to approximately 25% of a diameter of the optical fiber 100. Removal of the jacket 108, the buffer 106, and the cladding 104 allows light to escape from the transparent core 102 in a direction generally perpendicular to a long axis 109 of the optical fiber 100. In other embodiments, abrasion may be performed such that light may escape from the transparent core 102 at any angle relative to the long axis 109 of the optical fiber.

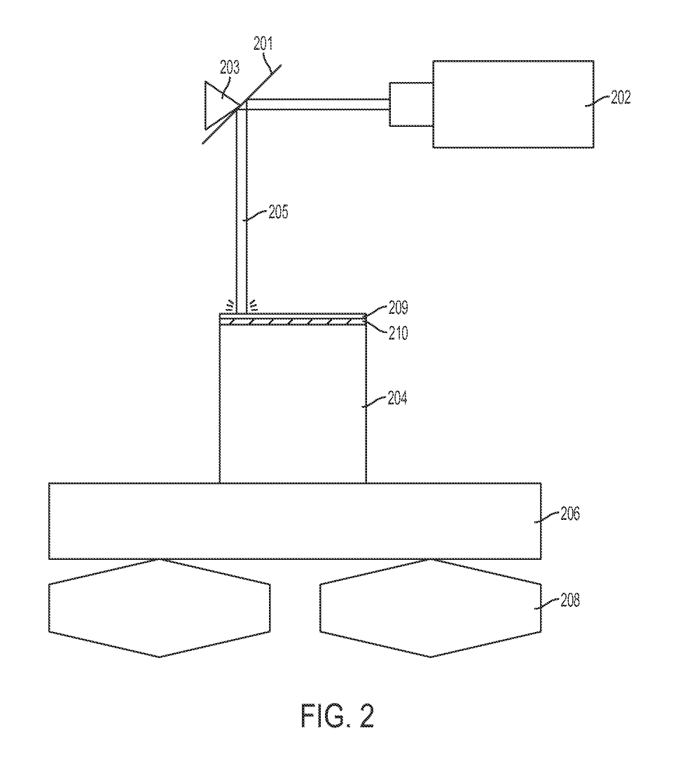

FIG. 2 is a schematic diagram of a system for abrasion of optical fibers according to an exemplary embodiment. A system 200 includes a laser 202 mounted above a focus block 204. A mirror 201 is disposed in front of the laser 202. The mirror 201 is coupled to a pivot joint 203. The pivot joint 203 may be electrically actuated via a controller (not shown). In a typical embodiment, the pivot joint 203 moves the mirror 201 in two dimensions such that a beam 205 emitted from the laser 202 may be directed to all points on a top surface of the focus block 204. The focus block 204 is secured to a platform 206. In a typical embodiment, the focus block 204 is constructed from an etch-resistant material such as, for example, aluminum. The platform 206 rests on an adjustment member 208. In a typical embodiment, the adjustment member 208 is, for example, a scissor lift. However, in other embodiments, other devices such as, for example, a jack screw, a hydraulic lift, an electric lift, or a pneumatic lift may be utilized. In an exemplary embodiment, the laser 202 has an output frequency having a range of approximately 20 to approximately 500 kilohertz and a wave length of approximately 1,000 to approximately 1,200 nanometers. However, in other embodiments, any type of laser, having different output frequencies and wavelengths, such as, for example, a red-light laser, a green-light laser, and a white-light laser may be utilized.

During operation, a fiber optic array 210 is placed on the focus block 204. The adjustment member 208 is actuated in a vertical direction to define a focus plane of the laser 202 that is coextensive with the fiber-optic array 210. A glass layer 209 is placed above the fiber-optic array 210. The glass layer 209 secures the fiber-optic array 210 in the focus plane and prevents the formation of “hot spots” or “cold spots” due to uneven placement of the fiber-optic array 210. In a typical embodiment, the glass layer 209 is an optically transparent and etch resistant material such as, for example, borosilicate glass; however, in other embodiments, other appropriate materials could be utilized. In various embodiments, systems utilizing principles of the invention may omit the glass layer 209.

Still referring to FIG. 2, after focusing, the laser 202 directs the beam 205 onto the fiber optic array 210, which burns away at least a portion of the jacket 108 (shown in FIG. 1A), the buffer 106 (shown in FIG. 1A), and the cladding 104 (shown in FIG. 1A). Removal of the jacket 108, the buffer 106, and the cladding 104 allows light to exit the fiber optic array 210 in a direction generally perpendicular to a long axis 109 (shown in FIG. 1A) of the fiber optic array. In other embodiments, however, the jacket 108, the buffer 106, and the cladding 104 may be removed so as to allow light to exit the fiber optic array 210 at any angle relative to the long axis 109 of the fiber optic array 210. The pivot joint 203 moves the mirror 201 in two dimensions thereby directing the beam 205 to all parts of the fiber optic array 210 positioned on the focus block 204.

Still referring to FIG. 2, in a typical embodiment, the beam 205 removes approximately 10% to approximately 25% of a diameter of each optical fiber of the fiber optic array 210; however, in other embodiments, different burn depths may be utilized. In other embodiments, the mirror 201 is omitted. In such embodiments, a pivot (not shown) may be utilized to direct the beam 205 to various points on the fiber optic array 210. In still other embodiments, movement of the laser 202 may be programmable to burn, for example, numbers, letters, or other patterns into the fiber optic array 210. A speed of movement of the laser 202 may be varied to adjust a burn depth of the laser 202. In other embodiments, the burn depth of the laser 202 may be adjusted by varying an intensity or a frequency of the laser 202.

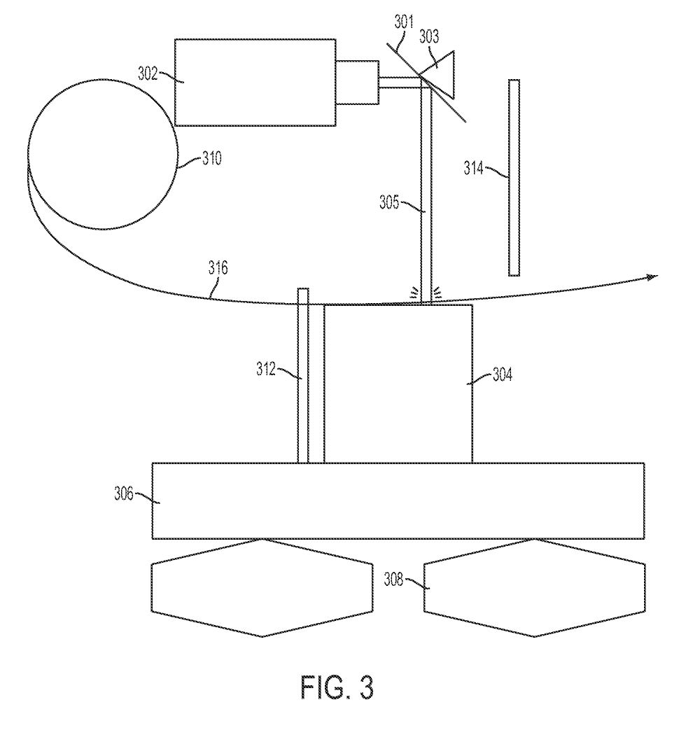

FIG. 3 is a schematic diagram of a system for abrasion of optical fibers utilizing an automated input according to an exemplary embodiment. A system 300 includes a laser 302 mounted above a focus block 304. A mirror 301 is disposed in front of the laser 302. The mirror 301 is coupled to a pivot joint 303. The pivot joint 303 may be electrically actuated by via a controller (not shown). In a typical embodiment, the pivot joint 303 pivots the mirror 301 in two dimensions such that a beam 305 emitted from the laser 302 may be directed to all points on a top surface of the focus block 304. The focus block 304 rests upon a platform 306. The platform 306 is adjusted by an adjustment member 308. The laser 302, the focus block 304, the platform 306, and the adjustment member 308 are similar to the laser 202, the focus block 204, the platform 206, and the adjustment member 208 discussed above with respect to FIG. 2. An optical-fiber supply 310 is arranged adjacent to the focus block 304. In a typical embodiment, the optical-fiber supply 310 is a reel; however, in other embodiments, other types of optical-fiber supplies could be utilized such as, for example, a multi-reel supply or a batch arrangement. Optical fibers 316 are stored on the optical-fiber supply 310. A separator device 312 is positioned between the optical-fiber supply 310 and the focus block 304. In a typical embodiment, the separator device 312 is a comb-like structure having a plurality of generally parallel teeth (not shown). A cleaving tool 314 is positioned adjacent to the focus block 304 on a side opposite the separator device 312. After abrasion, the cleaving tool 314 separates the abraded optical fibers 316 from the optical-fiber supply 310. In some embodiments, systems utilizing principles of the invention may omit the cleaving tool 314. In such embodiments, for example, the laser 302 is utilized to separate the abraded optical fibers 316 from the optical fiber supply 310.

During operation, the optical fibers 316 are drawn off the optical-fiber supply 310 and through the separator device 312. The separator device 312 separates and aligns the optical fibers 316. The optical fibers 316 are positioned on the focus block 304. The laser 302 directs the beam 305 onto the optical fibers 316, which burns away at least a portion of the jacket 108 (shown in FIG. 1A), the buffer 106 (shown in FIG. 1A), and the cladding 104 (shown in FIG. 1A). Removal of the jacket 108, the buffer 106, and the cladding 104 allows light to exit the optical fibers 316 in a direction generally perpendicular to a long axis 109 (shown in FIG. 1A) of the optical fibers 316. In other embodiments, however, the jacket 108, the buffer 106, and the cladding 104 may be removed so as to allow light to exit the optical fibers 316 at any angle relative to the long axis 109 of the optical fibers 316. The pivot joint 303 moves the mirror 301 in two dimensions thereby directing the beam 305 to all parts of the optical fibers 316 positioned on the focus block 304.

Still referring to FIG. 3, in a typical embodiment, the beam 305 removes approximately 10% to approximately 25% of a diameter of the optical fibers 316; however, in other embodiments, different burn depths may be utilized. In other embodiments, the mirror 301 is omitted. In such embodiments, a pivot joint (not shown) may be utilized to move the laser 302 direct the beam 305 to various points on the optical fibers 316. In still other embodiments, movement of the laser 302 may be programmable to burn, for example, numbers, letters, or other patterns into the optical fibers 316. A speed of movement of the laser 302 may be varied to adjust a burn depth of the laser 302. In a typical embodiment, the laser 302 makes several passes over the optical fibers 316. After abrasion, the cleaving tool 314 separates the abraded optical fibers 316 from the optical-fiber supply 310.

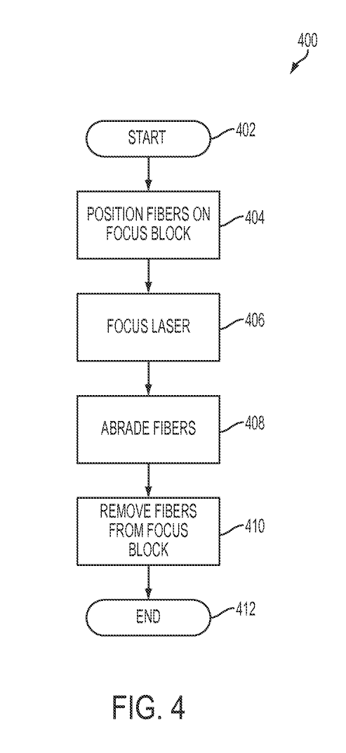

FIG. 4 is a flow diagram of a method for abrading optical fibers. A process 400 begins at step 402. At step 404, a fiber optic array 210 is positioned on the focus block 204. At step 406, the adjustment member 208 is actuated to focus the laser 202. At step 408, the laser 202 abrades the fiber optic array 210. At step 410, the fiber optic array 210 are removed from the focus block 204. Although the process 400 has been described as utilizing the system 200 shown in FIG. 2, one skilled in the art will recognize that the process 400 could also utilize the system 300 shown in FIG. 3.

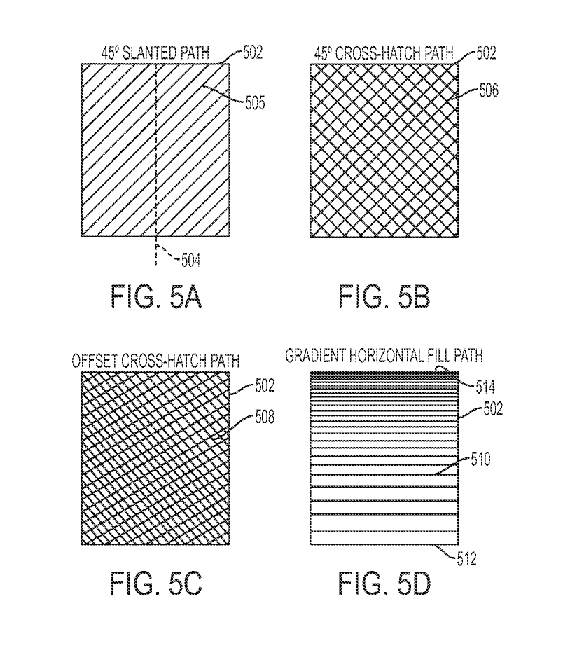

FIGS. 5A-5D are illustrations of laser etch patterns according to exemplary embodiments. As shown in FIG. 5A, a laser such as, for example, the laser 202 (shown in FIG. 2) or the laser 302 (shown in FIG. 3) moves a beam such as, for example the beam 205 (shown in FIG. 2) or the beam 305 (shown in FIG. 3) across a fiber-optic array 502 in a direction 505 oriented at approximately 45 degrees to an axis 504 of the fiber optic array 502. As shown in FIG. 5B, the laser moves the beam across the fiber-optic array 502 in a cross-hatch pattern 506. As shown in FIG. 5C, the laser moves the beam across the fiber-optic array 502 in an offset cross-hatch pattern 508. The offset cross-hatch pattern 508 reduces repeated exposure of a single optical fiber of the fiber-optic array 502 to the beam. As shown in FIG. 5D, the laser moves the beam across the fiber-optic array 502 in a gradient pattern 510. The gradient pattern 510 increases a density of beam exposure from a proximal end 512 of the fiber-optic array 502 to a distal end 514 of the fiber optic array 502.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A system for abrasion of optical fibers, the system comprising:
an adjustment member;
a platform disposed on the adjustment member;
a focus block disposed on the platform;
a laser disposed above, and in optical alignment with, the focus block; and
wherein the laser abrades an optical fiber positioned on the focus block.

2. The system of claim 1, comprising a glass layer disposed on the optical fiber and that secures the optical fiber in a focus plane.

3. The system of claim 1, comprising a mirror disposed between the laser and the focus block.

4. The system of claim 3, wherein the mirror changes a direction of a beam emitted from the laser.

5. The system of claim 1, wherein the optical fiber is drawn from an optical fiber source positioned adjacent to the focus block, the optical fiber source comprising a plurality of optical fibers.

6. The system of claim 5, comprising a separator device positioned between the optical fiber source and the focus block and that separates and aligns the plurality of optical fibers in a focus plane.

7. The system of claim 5, comprising a cleaving tool positioned adjacent to the focus block opposite the optical fiber source and for cleaving abraded optical fibers from the optical fiber source.

8. The system of claim 5, wherein the laser cleaves abraded optical fibers from the optical fiber source.

9. The system of claim 1, wherein the adjustment member moves in a vertical direction to align the optical fiber with a focus plane.

10. The system of claim 1, wherein the laser removes approximately 10% to approximately 25% of a diameter of the optical fiber.

11. A method for abrading optical fibers, the method comprising:
positioning an optical fiber on a focus block;
focusing, via an adjustment member, a laser on the optical fiber; and
abrading, via the laser, the optical fiber.

12. The method of claim 11, comprising securing the optical fiber in a focus plane via a glass layer.

13. The method of claim 11, wherein the abrading comprises moving a beam emitted from the laser, via a mirror, across the optical fiber.

14. The method of claim 11, wherein the positioning comprises drawing the optical fiber to the focus block from an optical fiber source, the optical fiber source comprising a plurality of optical fibers.

15. The method of claim 14, wherein the drawing comprises separating and aligning the plurality of optical fibers via a separator device.

16. The method of claim 14, comprising cleaving an abraded optical fiber with a cleaving tool.

17. The method of claim 14, comprising cleaving an abraded optical fiber with the laser.

18. The method of claim 14, wherein the abrading comprises forming at least one of letters, numbers, logos, and patterns into the plurality of optical fibers.

19. The method of claim 11, wherein the abrading comprises removing approximately 10% to approximately 25% of a diameter of the optical fiber.

20. The method of claim 11, wherein the focusing comprises moving the adjustment member in a vertical direction to align the optical fiber with a focus plane.
